(19) United States
(12) Patent Application Publication
(10) Pub. No.: US 2004/0071307 A1
(43) Pub. Date: Apr. 15, 2004

(54) Dual magnetic loop type receiver

(75) Inventor: Jui-Cheng Chang, Taichung (TW)

Correspondence Address: BROWDY AND NEIMARK, P.L.L.C., 624 NINTH STREET, NW, SUITE 300, WASHINGTON, DC, 20001-5303, US

(73) Assignee: Merry Electronics Co., Ltd., Taichung (TW)

(21) Appl. No.: 10/340,751

(22) Filed: Jan. 13, 2003

(30) Foreign Application Priority Data
Oct. 14, 2002 (TW) 91216264

(51) Int. Cl. H04R 1/00; H04R 9/06; H04R 11/02

(52) U.S. Cl. 381/396; 381/412; 381/401

(57) ABSTRACT

A dual magnetic loop type receiver is composed of a yoke molding, a yoke piece, an annular magnet, a magnetic pole member, a pressure plate, a circular plate, and a vibration panel. While the receiver is operated, the annular magnet and the yoke piece cause the receiver to produce an inner magnetic loop that interacts with the inner voice coil and an outer magnetic loop that interacts with the outer voice coil such that the receiver generates vibration and sound.

### BACKGROUND OF THE INVENTION

1. Field of the Invention

The present invention relates to telecommunication apparatus, and more specifically to a dual magnetic loop type receiver, which uses a single magnet to produce two magnetic loops and to further provide multiple functions.

2. Description of the Related Art

As shown in FIG. 1, a conventional moving coil receiver 90 has only one simple function. Inputted electric energy causes the sound coil 91 and a magnet 92 of the moving coil receiver 90 to produce a coupling effect and to further move a vibration panel 93. When the vibration panel 93 is vibrated, air molecules contacting the vibration panel 93 are excited to produce a variable dense-disperse wave (longitudinal wave). The amount of variation of the dense-disperse wave is the waveform of sound pressure audible to human ears.

However, the receiver 90 can only produce a magnetic loop to convert electric energy into sound energy without any other added functions. Therefore, while installed in an electronic telecommunication apparatus (for example, a cellular phone), two component parts (a receiver and a vibrator) are required to achieve sound producing and vibration functions. In recent years, it has been the market tendency to make electronic apparatus thinner and smaller and to provide electronic apparatus with user-friendly operation interfaces. When designing the receiver, which is a key component for electronic telecommunication apparatus, factors of high performance, low consumption of power, flat and compact outer appearance, and low cost should be taken into account.

### SUMMARY OF THE INVENTION

It is the primary object of the present invention to provide a dual magnetic loop type receiver, which provides sound producing and vibration functions and requires less installation space. It is another object of the present invention to provide a dual magnetic loop type receiver, which is inexpensive to manufacture. To achieve the foregoing objects of the present invention, the dual magnetic loop type receiver includes a yoke molding, a yoke piece, an annular magnet, a magnetic pole member, a circular plate, and a vibration panel. The yoke molding has an axially extended receiving open space. The yoke piece is mounted in the receiving open space of the yoke molding and has a center shaft coaxially suspended in the receiving open space of the yoke molding. The annular magnet is mounted in the receiving open space of the yoke molding and has a center through hole for the center shaft of the yoke piece passing through. The magnetic pole member is mounted in the receiving open space of the yoke molding and is supported on the annular magnet. The circular plate is mounted in the receiving open space of the yoke molding and has an annular springy body portion, which is provided with a circular center through hole in coaxial alignment with the center through hole of the annular magnet. The annular springy body portion has an outer voice coil axially extending from an inner periphery of the annular springy body portion toward the annular magnet. The vibration panel is mounted in the receiving open space of the yoke molding and is supported on the magnetic pole member and has a diaphragm positioned in a recessed center area thereof and an inner voice coil axially extending from a side thereof around the periphery of the diaphragm. Accordingly, while the receiver is operated, the receiver produces two magnetic loops, which interact with aforementioned component parts to generate vibration, sound, and other functions.

### BRIEF DESCRIPTION OF THE DRAWINGS

FIG. 1 is a sectional view of a conventional receiver.

FIG. 2 is an exploded view of a first preferred embodiment of the present invention.

FIG. 3 is a perspective view of the first preferred embodiment of the present invention.

FIG. 4 is a sectional view taken along a line 4-4 indicated in FIG. 3.

FIG. 5 is a sectional view of a second preferred embodiment of the present invention.

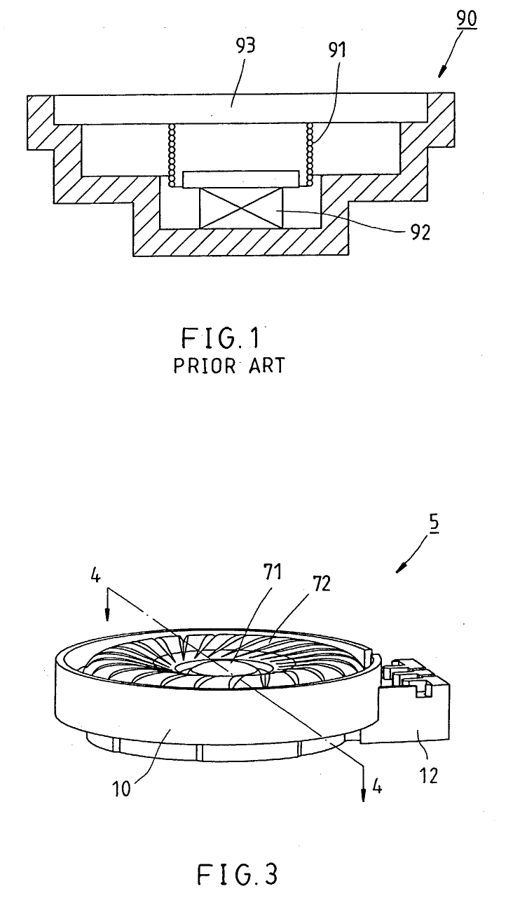

### DETAILED DESCRIPTION OF THE INVENTION

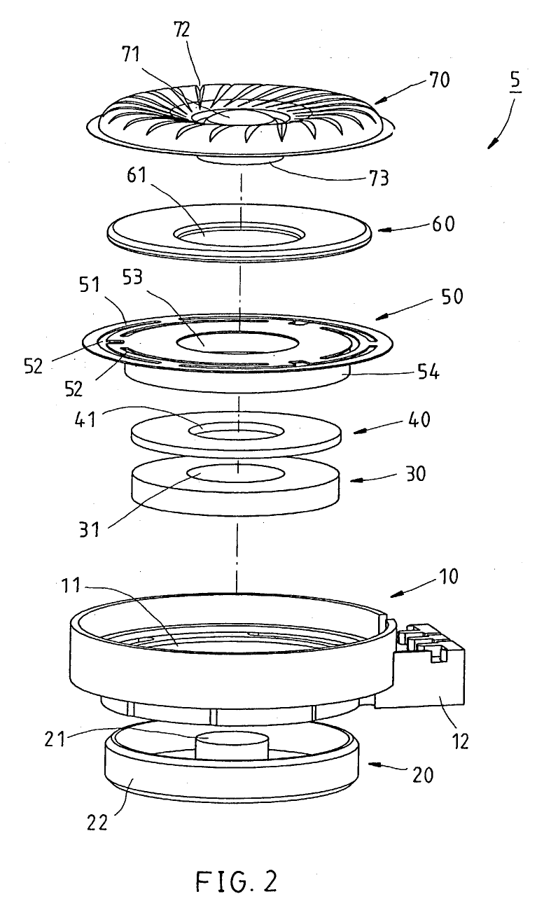

Referring to FIGS. 2 and 3, a dual magnetic loop type receiver 5 according to a first preferred embodiment of the present invention is composed of a yoke molding 10, a yoke piece 20, an annular magnet 30, a magnetic pole member 40, a circular plate 50, a pressure plate 60, and a vibration panel 70.

The yoke molding 10 is shaped like a round pot and includes an axially extending receiving open space 11 adapted to receive the other component parts of the receiver, and an endpiece 12 protruding from a lateral periphery thereof for connecting a circuit board (not shown).

The yoke piece 20 is mounted at a peripheral fringe of the receiving open space 11 of the yoke molding 10 and has a center shaft 21 axially suspended in the center of the receiving open space 11 and an upright peripheral wall 22 extending toward the receiving open space 11 of the yoke molding 10 from a periphery thereof.

The annular magnet 30 is mounted within the receiving open space 11 of the yoke molding 10 and is supported on the yoke piece 20 and has a center through hole 31 positioned in coaxial alignment with the center shaft 21 of the yoke piece 20 for fitting with the annular magnet 30. The diameter of the center through hole 31 of the annular magnet 30 is greater than the outer diameter of the center shaft 21 of the yoke piece 20 such that a predetermined distance exists between a periphery of the center through hole 31 and the periphery of the center shaft 21.

The magnetic pole member 40 is mounted within the receiving open space 11 of the yoke molding 10 and is supported on the annular magnet 30 and has a center through hole 41 set in axial alignment with the center through hole 31 of the annular magnet 30 for passing through by the center shaft 21 of the yoke piece 20. The diameter of the center through hole 41 is greater than the outer diameter of the center shaft 21 of the yoke piece 20 such that a predetermined distance exists between the periphery of the center through hole 41 and the periphery of the center shaft 21.

The circular plate 50 is mounted within the receiving open space 11 of the yoke molding 10 and is supported on the magnetic pole member 40 and has an annular springy body portion 51, a circular center through hole 53 running through the center of the annular springy body portion 51, a plurality of smoothly arched slots 52 running through the annular springy body portion 51, and an outer voice coil 54 axially extending from a side of the annular springy body portion 51 around a periphery of the circular center through hole 53 and suspended around an outer periphery of the magnetic pole member 40 and an outer periphery of the annular magnet 30. While the outer voice coil 54 is installed to the circular plate 50, a gap exists between an inner periphery of the outer voice coil 54 and outer peripheries of the magnetic pole member 40 and the annular magnet 30.

The pressure plate 60 is a circular plate member mounted within the receiving open space 11 of the yoke molding 10 and is supported on the circular plate 50 and has a center through hole 61 in coaxial alignment with the circular center through hole 53 of the circular plate 50. The top surface of the pressure plate 60 curves inwards and slopes downward in a direction toward the center through hole 61 from a periphery of the pressure plate 60. The pressure plate 60 enhances the inertia effect of the receiver 5 during its operation.

The vibration panel 70 is mounted within the receiving open space 11 of the yoke molding 10 and is supported on the pressure plate 60. The vibration panel 70 has a diaphragm 71 recessed an inner side of the center thereof and positioned in coaxial alignment with the annular magnet 30, and a radially stripped suspension portion 72 positioned at a periphery of the diaphragm 71. The vibration panel 70 further has an inner voice coil 73 axially extending toward the annular magnet 30 from a side of the diaphragm 71. While the inner voice coil 73 is mounted to with the vibration panel 70, the inner voice coil 73 is inserted through the center through hole 61 of the pressure plate 60 and the circular center through hole 53 of the circular plate 50 into the gap between a periphery of the center shaft 21 and the peripheries of the annular magnet 30 and the magnetic pole member 40.

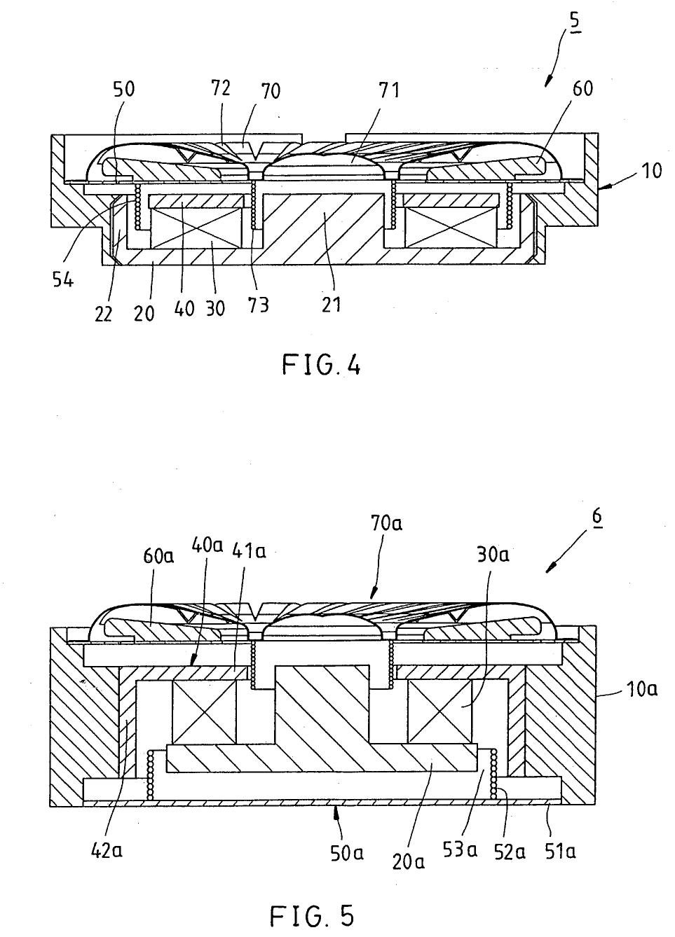

Referring to FIG. 4, while the receiver 5 is operated, the annular magnet 30 and the yoke piece 20 cause the receiver 5 to produce an inner magnetic loop interacting with the inner voice coil 73, and an outer magnetic loop interacting with the outer voice coil 54. The arched slots 52 of the annular springy body portion 51 of the circular plate 50 reduce the production of eddy current during the interaction between the inner voice coil 73 and outer voice coil 54 so as to lower the production of resistance. While a current signal is inputted into the inner voice coil 73, it couples with the inner magnetic loop to produce a driving energy that passes through the annular springy body portion 51 of the circular plate 50 to the receiver 5 to produce vibrations. While a current signal is inputted into the outer voice coil 54 at the same time, it couples with the outer magnetic loop to provide a driving energy that drives the diaphragm 71 to vibrate subject to the cycle of the inputted current signal and to further compress air so as to result in the production of sound.

Referring to FIG. 5, the dual magnetic loop type receiver 6 of a second preferred embodiment of the present invention, is composed of a yoke molding 10a, a yoke piece 20a, an annular magnet 30a, a magnetic pole member 40a, a circular plate 50a, a pressure plate 60a, and a vibration panel 70a. The functions and designs of the component parts of the second preferred embodiment are substantially the same as the aforesaid first preferred embodiment with the exception of the following minor differences. According to this embodiment, the yoke molding 10a is shaped like a short cylinder having a receiving open space 11a axially extending through the center. The annular springy body portion 51a of the circular plate 50a is disposed at a peripheral fringe of the receiving open space 11a of the yoke molding 10a. The outer voice coil 52a extends axially from the top side of the annular springy body portion 51a and is inserted into the receiving open space 11a of the yoke molding 10a and has a receiving chamber 53a within the receiving open space 11a of the yoke molding 10a for receiving the yoke piece 20a. The yoke piece 20a is disposed above the circular plate 50a without the aforesaid upright peripheral wall 22 (see FIG. 2). A bottom side of the yoke piece 20a is suspended in the receiving chamber 53a and is spaced apart from the outer voice coil 52a at a predetermined distance.

Furthermore, the magnetic pole member 40a includes an annular body portion 41a mounted on the annular magnet 30a, and a peripheral flange portion 42a axially extending toward the circular plate 50a from an outer periphery of the annular body portion 41a and suspended around the annular magnet 30a, the yoke piece 20a and the outer voice coil 50a with a gap left therebetween.

When the receiver 6 is operated, two magnetic loops are produced to interact with the aforesaid component parts of the present invention, thereby causing the receiver 6 to produce vibration and sound.

As indicated above, the present invention has the following advantages:

1. The dual magnetic loop type receiver combines two component parts (the receiver and the vibrator) of a cellular phone into an integrated device so as to reduce cellular phone internal installation space and to improve the cellular phone working efficiency and to reduce waste of resources.

2. The present invention meets the electronic telecommunication apparatus's current design focus, which is characterized in being thinner, smaller, and shorter, and greatly reducing material cost and assembly cost.

3. When applied in a cellular phone, the present invention provides voice amplifying and caller ringing functions without producing increased magnetic waves that are harmful to human beings and traffic security.

What is claimed is:

1. A dual magnetic loop type receiver comprising:
a yoke molding having an axially extending receiving open space;
a yoke piece mounted in said yoke molding and having a center shaft coaxially suspended in the receiving open space of said yoke molding;
an annular magnet mounted in the receiving open space of said yoke molding and having a center through hole for the center shaft of said yoke piece passing through;
a magnetic pole member mounted in the receiving open space of said yoke molding and positioned on said annular magnet and having a center through hole in coaxial alignment with the center through hole of said annular magnet;
a circular plate mounted in the receiving open space of said yoke molding and having an annular springy body portion and an outer voice coil axially extending from a side of said annular springy body portion toward said annular magnet; and
a vibration panel mounted in the receiving open space of said yoke molding and positioned on said magnetic pole member and having a diaphragm suspended in a recessed center area thereof and an inner voice coil axially extending from a side thereof around the periphery of said diaphragm for receiving in the center through hole of said annular magnet and the center through hole of said magnetic pole member and for suspending around the center shaft of said yoke piece;
whereby, while said receiver is operated, said annular magnet and said yoke piece cause said receiver to produce an inner magnetic loop that interacts with said inner voice coil and an outer magnetic loop that interacts with said outer voice coil such that said receiver generates vibration and sound.

2. The dual magnetic loop type receiver as defined in claim 1, wherein said yoke piece has an upright peripheral wall extending into the receiving open space of said yoke molding and suspended around said outer voice coil.

3. The dual magnetic loop type receiver as defined in claim 2, wherein the annular springy body portion of said circular plate is mounted on said annular magnet and has a circular center through hole in coaxial alignment with the center through hole of said annular magnet; wherein said outer voice coil is axially extending from a side of said annular springy body portion around the periphery of the circular center through hole of said annular springy body portion and suspended around said magnetic pole member and said annular magnet.

4. The dual magnetic loop type receiver as defined in claim 1, wherein said annular springy body portion of said circular plate is disposed in a peripheral fringe of the receiving open space of said yoke molding; wherein said outer voice coil extends axially from said annular springy body portion toward said yoke piece and forming a receiving chamber for receiving said yoke piece.

5. The dual magnetic loop type receiver as defined in claim 4, wherein said yoke piece is disposed above said circular plate and is spaced apart from said outer voice coil at a distance.

6. The dual magnetic loop type receiver as claimed in claim 1 further comprising a pressure plate positioned between said magnetic pole member and said vibration panel, said pressure plate having a center through hole for said inner voice coil passing through.

7. The dual magnetic loop type receiver as defined in claim 6, wherein said pressure plate has a top surface curved inwards and sloping downwards in a direction toward the center through hole thereof from a periphery thereof.

8. The dual magnetic loop type receiver as defined in claim 1, wherein said annular springy body portion of said circular plate has a plurality of smoothly arched slots therethrough for reducing the production of eddy current while said inner voice coil and said outer voice coil interact so as to reduce the production of resistance.

9. The dual magnetic loop type receiver as defined in claim 1, wherein said diaphragm of said vibration panel has a radially stripped suspension portion around a periphery thereof.

10. The dual magnetic loop type receiver as defined in claim 1, wherein said yoke molding has an endpiece protruding from an outer periphery thereof.
